(19) United States
(12) Patent Application Publication
(10) Pub. No.: US 2009/0256800 A1
(43) Pub. Date: Oct. 15, 2009

(54) VIRTUAL REALITY SIMULATOR HARNESS SYSTEMS

(76) Inventor: Roger E. Kaufman, McLean, VA (US)

Correspondence Address: JUNEAU PARTNERS, P.O. BOX 2516, ALEXANDRIA, VA, 22301, US

(21) Appl. No.: 12/095,315

(22) PCT Filed: Nov. 8, 2006
(86) PCT No.: PCT/US06/43719

§ 371 Date: May 11, 2009

Related U.S. Application Data
(60) Provisional application No. 60/739,897, filed on Nov. 28, 2005.

(51) Int. Cl. G09G 5/00; G06F 3/00

(52) U.S. Cl. 345/156; 715/700

(57) ABSTRACT

The inventions are directed to assemblies for interfacing three-dimensional movements of a person to a virtual environment or to a remote environment. The harness assemblies maintain the user in a desired location with respect to the virtual reality system thereby allowing the virtual reality system to capture the movements of the user The assemblies include a frame subsystem, a pivot subsystem, a cable management subsystem, a compliance subsystem, a vertical motion subsystem, a centering adjustment subsystem, a support arm subsystem, and a human restraint subsystem.

### RELATED APPLICATION

This application claims priority to U.S. Provisional Application 60/739,897, filed Nov. 28, 2005.

### BACKGROUND AND SUMMARY

The inventions described in this patent document are directed to assemblies for interfacing three-dimensional movements of a person to a virtual environment or to a remote environment. More particularly, the inventions are directed to harness assemblies for use with a virtual reality system to maintain the user in the desired location with respect to the virtual reality system thereby allowing the virtual reality system to capture the movements of the user.

Virtual environments typically include an array of sensors that are actuated in response to a user's actions and motions and that give the user the impression of dealing directly with a three-dimensional model. The sensors may detect the positions of the user through the use of markers attached to the user, such as on the arms, legs, torso, pelvis and head. The positions of the markers within the virtual environment are detected by one or more sensors and recorded by a suitable computer system. Typically, a display system in the form of goggles or a mask containing a pair of small display screens is placed on the head of the user to display a dynamic image of the environment as the user virtually moves through it. The virtual environment can be computer generated or can use sensory input from a remote location. Virtual movement over long distances can be simulated in such a virtual environment by constraining a user to remain in a relatively small physical space and using the user's leg motions to indicate activities such as walking or jogging.

### BACKGROUND AND SUMMARY

The inventions described in this patent document are directed to assemblies for interfacing three-dimensional movements of a person to a virtual environment or to a remote environment. More particularly, the inventions are directed to harness assemblies for use with a virtual reality system to maintain the user in the desired location with respect to the virtual reality system thereby allowing the virtual reality system to capture the movements of the user.

Virtual environments typically include an array of sensors that are actuated in response to a user's actions and motions and that give the user the impression of dealing directly with a three-dimensional model. The sensors may detect the positions of the user through the use of markers attached to the user, such as on the arms, legs, torso, pelvis and head. The positions of the markers within the virtual environment are detected by one or more sensors and recorded by a suitable computer system. Typically, a display system in the form of goggles or a mask containing a pair of small display screens is placed on the head of the user to display a dynamic image of the environment as the user virtually moves through it. The virtual environment can be computer generated or can use sensory input from a remote location. Virtual movement over long distances can be simulated in such a virtual environment by constraining a user to remain in a relatively small physical space and using the user's leg motions to indicate activities such as walking or jogging.

Virtual reality systems typically include markers attached to various points on the person's body to aid in detecting the movement and location of the body parts. The systems often use a series of cameras or other sensors surrounding the person to detect the movement of the person's body parts and the positions of the markers. The camera system detects the positions and their movement and transmits signals to a computer where a real time image of the person's movement is produced. These devices generally require the user to operate in a limited space in order to remain within the field of view of the cameras or sensors. Also, for economic reasons, it is often desirable to keep the user in a small area. For instance, it might be desirable to put multiple virtual reality users into a single virtual room even though they are working in different physical environments. Therefore, there is a need in the industry for an assembly that maintains the user within the predetermined space for detecting the movement in a virtual reality system.

The present inventions are directed to mechanical centering harnesses that allow a person to move freely within a designated space. Each of these harnesses constrains the user to a designated location and provides a restoring force when the user moves out of the designated region. This force provides an ergonomic cue to the user and urges the user back into the designated area.

In one embodiment, the harness is attached to a frame and is attached to the user to restrain the user within a designated area while allowing the user to move his or her arms and legs and rotate about a vertical axis. The harness is connected to the user in a manner that allows the user to move freely in certain desired directions while maintaining the user in the designated area. The harness allows the user to easily walk, run, turn, or perhaps lie down or crawl in place while the virtual reality sensors detect the movement of the user.

This sensed knowledge about the user's position in space can be used to generate different kinds of virtual information. For instance, it can be used to display an image to the user and to others networked to the user in response to the movement. The harness also enables the user to move up and down or to a squatting, crawling or prone position and to allow the user to rotate as desired (say, 360° or more) within the designated area. The harness is designed to interact with a virtual environment and includes structural elements to manage the electrical and video cables and to allow a largely unobstructed view for tracking cameras.

The inventions are particularly directed to harness assemblies comprising a frame subsystem, a pivot subsystem, a cable management subsystem, a centering adjustment subsystem, a compliance subsystem, a vertical motion subsystem, a support arm subsystem, and a human restraint harness subsystem that couples the user to the rest of the device. One or more of these subsystems may be omitted in a particular embodiment if that particular subsystem is unneeded for a certain harness application.

The frame subsystem provides support for the user and for the rest of the harness device. It also provides a stationary reference coordinate system within which the virtual reality sensor system can be calibrated. The frame subsystem has portions that engage portions of either the floor or overhead ceiling structures in the room in which the harness system is used.

The pivot subsystem allows the user to rotate as desired about a substantially vertical axis with respect to the frame. For instance, embodiments described herein permit unlimited rotations of 360° or more although it will be understood that rotation limiting devices could also be employed

The cable management subsystem serves to keep the cables associated with the virtual reality head mounted display system, active markers, ancillary switches and wires, computer signal lines, and the like from twisting or tangling as the user pivots or moves up and down.

The centering adjustment subsystem establishes the nominal position of the user in relation to said substantially vertical pivot axis. The centering adjustment subsystem serves to allow the harness mechanism to be adjusted so as to properly position different users relative to the central axis of the device. This central adjusted position will also be referred to herein as the “nominal” or “unloaded” position. This positioning is important in attaining a natural “feel” when the user is walking and turning in place. Otherwise, for example, a user may have the unnatural sensation of being constrained to move on the radius of a circle rather than turning in place. In some situations the centering adjustment may be accomplished by constructing components of other subsystems to fixed proportions established to meet the typical needs of most users. In these situations the centering adjustment subsystem may be non-adjustable during normal use.

The compliance subsystem provides a centering force to the user. The compliance subsystem serves to provide a desired “springiness” or elasticity to the harness. This allows the user to move a slight distance off of the central axis in a natural fashion but with force cues gently guiding the user back towards the center. The compliance also helps to prevent parts of the harness from being overloaded and failing. The forces also may provide useful haptic (tactile) cues that aid the user in working with the harness device. They may enhance the simulated virtual reality experience, for instance by giving a feeling of actually working against a resistance while actually just jogging in place.

The vertical motion subsystem allows the user to move in a substantially up and down direction while substantially constraining horizontal motions. This may be a minor vertical motion such as accommodating the slight vertical displacements of the hips during walking or jogging in place or it may be a major vertical motion such as changing from a standing to a kneeling or prone position.

The human restraint harness serves to mechanically couple the user of the virtual reality harness to other portions of the system. In one embodiment the human restraint harness incorporates a wearable component such as a belt that attaches around the waist of the user. Ball joints on the belt allow the user to move freely within the intended constraints of the harness assembly. Locating these ball joints near to the hip joints of the user allows it to do this in a comfortable, ergonomic fashion. A backpack may also be incorporated as part of the human restraint harness to provide additional control and restraint to the user and to perform other functions, such as to carry elements of the cable management subsystem, to carry circuitry for the head mounted display system, or to provide mounting surfaces for markers used by the virtual reality sensor system.

The support arm subsystem rotates about the substantially vertical axis defined by said pivot subsystem. It allows the user to rotate about said substantially vertical axis with respect to said frame while providing and maintaining the needed horizontal and vertical offsets to keep the user spaced in the proper relationship with other said subsystems.

### BRIEF DESCRIPTION OF THEE DRAWINGS

The following is a brief description of the drawings, in which:

FIG. 1 is a conceptual view showing a user in a virtual environment with markers and sensors;

FIG. 2 is an oblique view of a virtual environment with a user coupled to one preferred embodiment of the invention;

FIG. 3, FIG. 4, and FIG. 5 are schematic representations of three possible embodiments of the present invention. Each of these figures shows only one possible arrangement of the components (subsystems) of a harness system. Most of these subsystems can be stacked or arranged in any sequence from top to bottom. Some subsystems, such as the compliance subsystem, can have their functions distributed over other systems and performed by those subsystems. Thus, some subsystems can be multi-functional. These figures illustrate how by interchanging modular components other embodiments can be configured.

FIG. 6 is a side view of a typical embodiment of the invention;

FIG. 7 is an oblique view of a single arm pedestal-style embodiment.

FIG. 8 is an oblique view from beneath the arm of a single arm pedestal-style embodiment.

FIG. 9 is an overall oblique view looking down on a single arm pedestal-style embodiment.

FIG. 10 is a detail view of one embodiment of the centering adjustment subsystem.

FIG. 11 is a detail view of one embodiment of the compliance subsystem and the human restraint harness subsystem.

FIG. 12 is an oblique view from beneath a dual arm embodiment of the pedestal-style device.

FIG. 13 is a side view of a pedestal-style embodiment with a straight-line vertical motion linkage mechanism.

FIG. 14 is an oblique view of the pedestal-style embodiment with the straight-line linkage mechanism shown in FIG. 13.

FIG. 15 is a detail view of one embodiment of a synchronizer mechanism as used in the FIG. 13 device. (Another is shown in FIG. 32.)

FIG. 16 is an oblique overall view of an overhead arm embodiment with a fixed central pivot column mounted to the ceiling.

FIG. 17 is a close up view of an overhead arm embodiment with a fixed central pivot column mounted to the ceiling.

FIG. 18 is an overall oblique view of the overhead arm embodiment of FIG. 16 but with the fixed central pivot column mounted to a framework standing on the floor.

FIG. 19 is an overall oblique view of an overhead arm embodiment with a fixed central pivot column mounted to a framework standing on the floor and with a centering adjustment and compliance mechanism embodiment between the pivot and the arm. The arm is a dual leg tubular arm embodiment.

FIG. 20 is an oblique view of the dual tubular arm subsystem 312 shown in FIG. 19.

FIG. 21 is a detail view of the centering adjustment and compliance mechanism embodiment of FIG. 19. Part of the pivot mechanism is also shown.

FIG. 22 shows a ceiling mounted embodiment with a straight-line vertical motion subsystem in its lowered position.

FIG. 23 shows the same embodiment in its raised position.

FIG. 24 shows a floor-mounted version of this same system.

FIG. 25 shows an oblique view of parts of the vertical motion linkage of the FIG. 22 embodiment.

FIG. 26 is an oblique view illustrating how the universal joint loop synchronizes the motion of the upper arm members.

FIG. 27 shows a detailed view of one third of the vertical motion mechanism of the embodiment of FIG. 22 with the linkage in the lowered position. (One set of articulated arms together with part of the center frame and the pivot hub.)

FIG. 28 shows the same oblique view but with the frame portions and the pivot mount omitted for clarity.

FIG. 29 shows details of the manner in which the linkage arm members attach to the center of the overhead frame.

FIG. 30 shows the center overhead details of a ceiling mounted embodiment with a composite arm system and with a straight-line vertical motion subsystem in its raised position.

FIG. 31 shows close up details of how the links of an overhead vertical motion mechanism attach to the pivot hub assembly.

FIG. 32 shows an alternate synchronizer linkage embodiment as it might be employed in an overhead linkage embodiment.

FIG. 33 shows a floor standing overhead arm embodiment with a dual tubular arm system and with a straight-line vertical motion subsystem in its raised position.

FIG. 34 shows a ceiling mounted embodiment with an alternate composite arm system embodiment and with a straight-line vertical motion subsystem in its raised position.

FIG. 35 shows an oblique view of an alternate straight-line overhead linkage embodiment with a “Sarrus” style mechanism.

FIG. 36 shows a side view of the FIG. 35 embodiment.

FIG. 37 shows a ceiling mounted embodiment with a diagonal composite arm system and with an arcuate approximate straight-line vertical motion subsystem in its raised position.

FIG. 38 shows a human restraint harness subsystem with supplemental stiffening and support provided by a specialized backpack structure coupled to the belt. (The web harness straps for the backpack are not shown.)

### DETAILED DESCRIPTION

The inventions are directed to harnesses designed to allow a person to run, walk, crawl and turn in place while being connected to a virtual reality system. Such harness assemblies are particularly suitable for training simulators for law enforcement, military, and the like, for practice of various maneuvers and operations. The harnesses are also suitable for other human computer interactions and simulator devices such as video arcade games where the user utilizes a virtual reality system. The harnesses could also be used in other situations not involving virtual reality wherein it is desired to constrain a user to move around while being constrained in place, such as in certain biomechanical studies.

The inventions are primarily directed to mechanical harness assemblies for maintaining the user within a designated area.

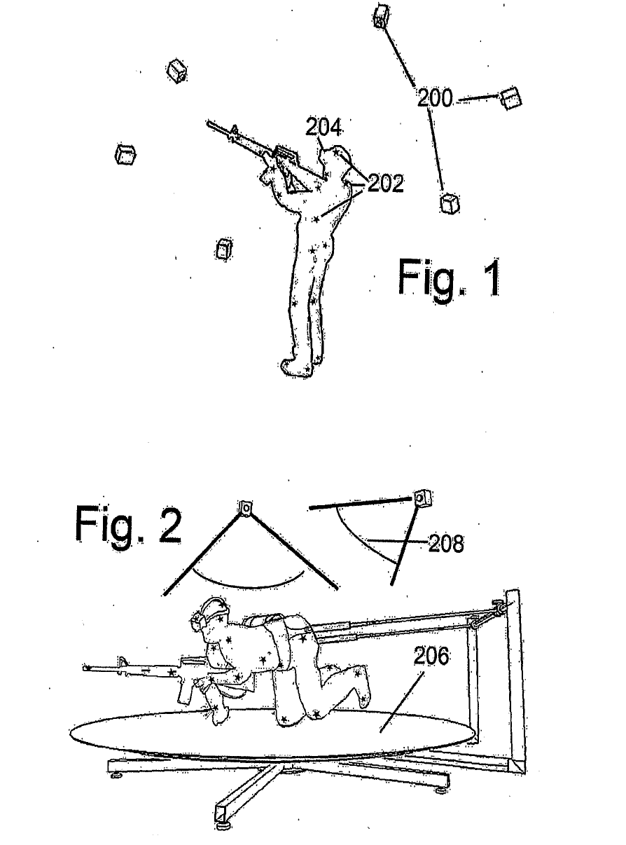

As shown in FIG. 1, a plurality of cameras or other types of sensors 200 are mounted at various locations surrounding the user to capture the positions and the actions of the user within the device. These sensors detect the positions of optical or magnetic markers 202 attached to various points on the subject's body. (The markers are shown oversize for clarity and to indicate typical attachment points on the limbs, torso, and objects manipulated by the user. The FIG. 1 and FIG. 2 examples show how they might be located in an application such as a combat training simulator.) By triangulation, the computer system can determine the user's orientation as long as the markers are within range of the sensors. The user of the present invention generally would be wearing a head-mounted display 204 of the general type worn by users in standard virtual reality systems. The head-mounted display 204 includes sound connections connected to headphones and a microphone worn by the user and an imaging means for viewing by the user during use. The imaging means and the appropriate software for producing the image in response to movement by the user or by others are known in the art.

FIG. 2 shows how one embodiment of the current invention 206 can be used to restrain the user within the limited field of view of the cameras or sensors 208. The harness assembly 206 restrains the user within a designed area corresponding to the field of view of the cameras or sensors 200. Such camera and sensor systems are also known in the art. These include optical markers and optical cameras, magnetic markers and sensors, active device markers and detectors of signals emitted by the active devices, reflexive devices, etc.

Several such cameras or sensors are positioned strategically to continuously capture the image of the movements by the user regardless of the position and orientation of the user. Overlapping fields of view 208 insure that the computers will have sufficient information on the positions of the markers 202 even if one or more are obstructed from view.

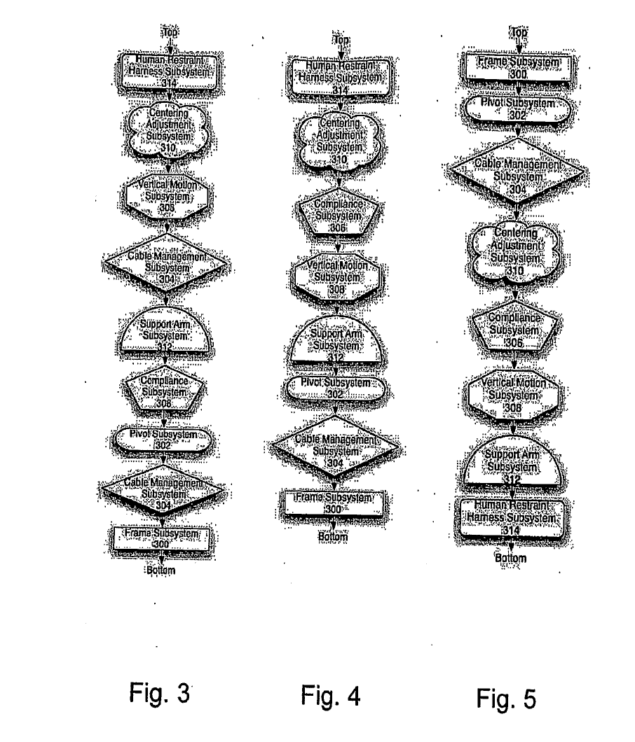

FIG. 3, FIG. 4, and FIG. 5 are schematic representations of three possible embodiments of the present invention. Each of these figures shows only one possible arrangement of the components (subsystems) of a harness system. Most of these subsystems can be stacked or arranged in any sequence from top to bottom. Some subsystems, such as the compliance subsystem, can have their functions distributed over other systems and performed by those subsystems. Thus, some subsystems can be multi-functional. These figures illustrate how by interchanging modular components other embodiments can be configured.

FIG. 3 schematically shows the components of the present invention. These are:

a. A Frame Subsystem 300

b. A Pivot Subsystem 302

c. A Cable Management Subsystem 304

d. A Compliance Subsystem 306

e. A Vertical Motion Subsystem 308

f. A Centering Adjustment Subsystem 310

g. A Support Arm Subsystem 312

h. A Human Restraint Harness Subsystem 314

As shown schematically in FIG. 3 these components can be tied together in various sequences to produce various embodiments of the inventions.

One possible embodiment could be created by the stacking order shown, roughly going from the top to the bottom of the device. Some components might also be tied together laterally rather than top to bottom. An example of this is shown in the embodiment of FIG. 2.

The functions of some of these subsystems can also be split up and distributed over other subsystems. Similarly, some subsystems can be merged into multifunctional subsystems.

FIG. 4 and FIG. 5 illustrate how other embodiments of the inventions can be implemented by choosing different sequences for the subsystems. Almost any intermediate sequence coupling said frame subsystem 300 to said human restraint harness subsystem 314 would result in a possible embodiment of the present invention. The three schematics shown (FIG. 3, FIG. 4, and FIG. 5) are simply arbitrarily chosen sequences to show how typical embodiments could be implemented. Several specific embodiments are illustrated by the following illustrations.

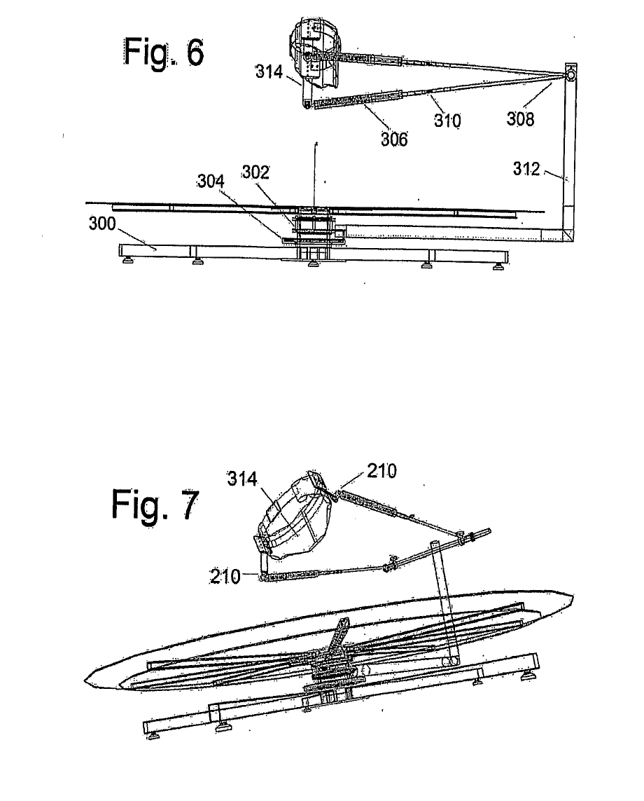

FIG. 6 shows an embodiment in which said human restraint harness subsystem 314 is coupled to a linear compliance subsystem 306. Said compliance subsystem 306 is coupled, in turn, to centering adjustment subsystem 310. Vertical motion subsystem 308 couples said centering adjustment subsystem 310 to support arm subsystem 312. Said support arm subsystem 312 is pivotally attached to frame subsystem 300 by pivot subsystem components 302.

Cable management subsystem 304 is also collinear with said pivot subsystem 302 and comprises a set of slip rings to handle the video and audio signals from the head mounted display. In that way, said support arm subsystem 312 can rotate continuously as needed and the cables won't get twisted or tangled. It will be appreciated that other non-contacting methods of signal transmission, such as optical, RF, or magnetic couplings are feasible alternatives to the use of slip rings for signal transmission from the fixed to the movable portions of the system as components of the cable management subsystem. If there is no need for continuous rotation, said slip rings 304 can perhaps be omitted and cable management could be implemented by other means. For instance, simply allowing extra cable length, perhaps in the form of a coiled cord, would allow oscillating rotation from side to side. It will be seen that the total number of turns clockwise or counterclockwise from the starting position would be limited in this case, due to the need to avoid tangling the cables.

FIG. 7 shows how said human restraint harness subsystem 314 comprises a wearable device such as a belt that can be coupled around the user's body so as to move with the user of the virtual reality harness system. Said human restraint harness subsystem 314 can rotate slightly if necessary to allow the user's hips to move up or down independently. Ball joints 210 are mounted on said human restraint harness roughly at the height of the user's hips. These joints pivotally couple the user to the rest of the virtual reality harness device.

Said ball joints 210 also allow the human restraint harness subsystem to tip when the user leans forward or backward or when the user goes into a prone position. Having the ball joints near the height of the user's hips allows them to ergonomically match the motions of the user with minimal hindrance of motion.

Said human restraint harness subsystem 314 also includes suitable couplings or clasps for securing the belt or other wearable embodiment of the harness to the user as is well known in the art.

It will be appreciated that other methods may be used to couple said ball joints 210 to the user. For instance, a specialized design of a backpack frame worn by the user could be substituted for the belt arrangement shown, or it could be designed to provide supplementary stiffening and support to the belt attached around the user's waist. Such a backpack/belt integrated human restraint harness system is shown in FIG. 38. (The web harness straps holding the backpack to the user's back are not shown but are of a type known in the art and similar to those used to secure a typical backpack to a user.)

In an alternative embodiment, brackets attached to a backpack frame could serve as mounting points for the ball joints 210. Similarly, the ball joints could be mounted to a flack jacket worn by the user or to holsters strapped to the user's legs or torso.

Almost any form of wearable component or attachment that comfortably maintains said ball joints 210 in position relative to the user's hips would be possible as a way of implementing said human restraint harness subsystem 314. Also, since limited motion is required, flexures or other types of limited motion joints could be substituted for said ball joints 210.

Although said human restraint harness subsystem 314 allows certain freedoms of rotation, if the user turns about a substantially vertical axis said support arm subsystem 312 will be forced to rotate accordingly as compelled by the members coupling the human restraint harness assembly 314 to said support arm subsystem 312.

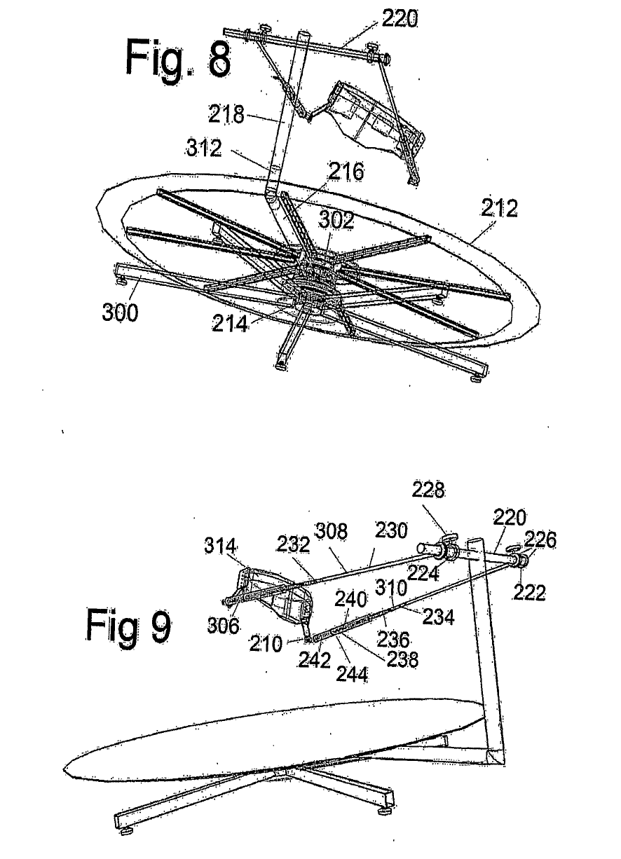

FIG. 8 shows a view looking up from beneath the device. The user stands on a false floor 212 portion of said frame subsystem 300. Said false floor 212 is rigidly attached to a central column 214 whose bottom portion is attached to the rest of the frame subsystem 300. This frame subsystem has ground engaging surfaces or feet. Thus 212 and 214 are part of said frame subsystem 300. The central column 214 carries the pivot bearings 302 on which the arm subsystem 312 rotates about a substantially vertical axis. The slip rings 304 have a hollow bore and surround the column 214. One portion of the slip ring assembly is stationary and attached to the frame subsystem 300 and the other portion rotates with the arm subsystem 312.

As shown in FIG. 8, the support arm subsystem 312 in the present embodiment is made up of one or more horizontal members 216 that rotate on bearings 302 beneath the false floor 212. Rigidly attached to the horizontal member or members 216 are intermediate spacing members 218. In the present embodiment shown this is the substantially vertical member 218. A second horizontal member which will hereafter be called the “pivot bar” 220 is rigidly mounted to the intermediate spacing members 218 to complete the main components of the support arm subsystem in the present embodiment.

In the present embodiment pivot bar 220 is perpendicular to both of the other two members (216 and 218) and serves as the primary horizontal hinge axis for the vertical motion subsystem.

As shown in FIG. 9, tubular sleeves 222 slide along the pivot bar 220 and serve as inner journal bearings for outer sleeve bearing shells 224. These sleeves have enlarged end stop rings 226 attached and can be locked to the pivot bar 220 by means of knobs 228.

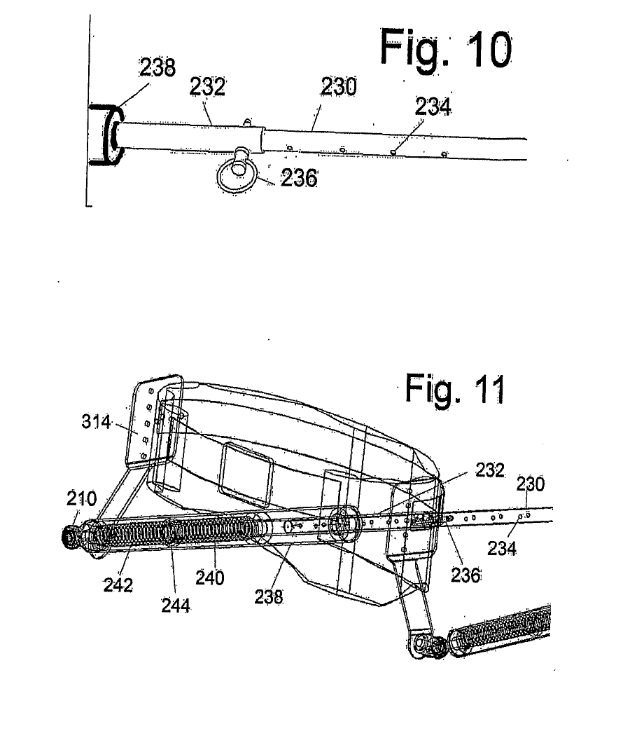

Attached to the outer sleeve shells 224 are tubular radius arms 230. These members telescope within tubular shock absorber members 232. Holes 234 in the telescoping members allow them to be locked together by means of quick release pins 236 as seen in FIG. 10.

FIG. 11 illustrates how shock absorber member 232 telescopes into a barrel 238 containing a pair of coil springs 240 and 242. It passes through spring 240 and engages the two springs at the center point 244 between the pair of springs. The outlying ends of the springs engage the ends of the barrel 238.

Finally, the other end of the barrel 238 attaches to the ball joint 210 attached to the human restraint harness subsystem 314.

Taken together, these parts 230, 232, and 236 comprise the centering adjustment subsystem 310 as shown in FIG. 9.

Parts 238, 240, 242, and 232 comprise the major parts of the compliance subsystem 306.

In the present embodiment, the radial links made up of the centering adjustment subsystems 310 coupled to the compliance subsystems 306 comprise the vertical motion subsystem 308. These assemblies effectively make up a pair of radial links on either side of the user coupling the ball joints 210 to the sleeve bearings 224. Due to the spring compliance subsystem 306, the length of these radial links will vary somewhat in response to the applied loads but effectively this combination of elements allows the ball joints 210 of said human restraint harness subsystem 314 to swing up and down on arcs centered around the pivot bar 220.

Due to the long length of these radial link assemblies, (approximately the radius of the arm system) the arcs traversed by the ball joints as the user goes from a standing to a reclined or kneeling position can be made to be an acceptably close approximation to straight vertical lines. This approximation can be optimized for most applications by letting the height of the horizontal pivot bar 220 be about at knee height so it is roughly midway between the height of the ball joints when the user is standing and when the user is reclined. The slight deviation of this arcuate path from true straight-line vertical motion is readily permitted by slight telescoping action of the compliance mechanism 306. Since the compliance subsystem 306 is telescoping about its central or “neutral” position, the forces imposed on the user by this slight compensation motion are minimal.

It will be appreciated that this embodiment can be constructed so as to provide the desired constraints on the freedom of motion of the user while providing minimal interference with desirable motions.

Further, this embodiment provides force feedback to the user via the compliance subsystem to help an “immersed user” in a virtual environment and wearing a head mounted display remain centered in the field of view of the sensors 200. The compliance subsystem provides very little centering force if the user is centered. As the user moves off center, the springs provide increasing amounts of restoring force cueing the user to move back to the center. By choosing appropriate spring constants this restoring force can be tailored to the needs of the application.

Use of lightweight components, such as composites like graphite or carbon fiber for the arm mechanism and for the compliance barrel 238 can be employed in preferred embodiments to minimize the rotational inertia loads felt by the user. The rotational inertias are further minimized in this embodiment by locating the heavy spring compliance components close in to the user's hips and keeping the outboard members as light as possible.

It will be appreciated that the various embodiments of this invention also incorporate various video, audio, and electrical connections that are connected to the switches, sensors, and headset worn by the user. For purposes of simplicity in the illustrations, the various wire and cable connections are not shown.

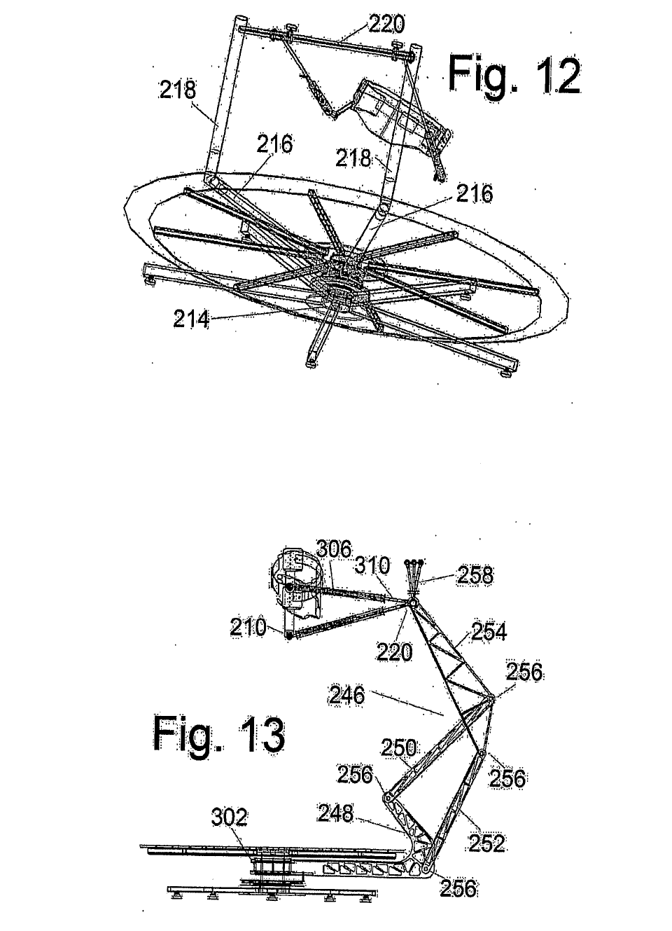

FIG. 12 illustrates an alternate embodiment in which a different arm configuration is employed. In this case, a pair of horizontal members 216 is rigidly attached to one another. The distal portions of these members are attached to a pair of vertical members 218. These members 218, in turn, are attached rigidly to the horizontal pivot bar 220.

Such a construction might be used to obtain greater rigidity than provided by the single L-shaped arm construction described earlier. The choice of arm design would be based on a compromise between the need for strength and the need for low rotational inertia. For instance, box beams or truss assemblies could be used in place of the tubular members shown for the arm.

It will be appreciated that there are many other construction techniques that could be used to implement the present invention. For instance, in many situations, the central column 214 could be mounted directly to the floor of the building eliminating the need for the feet and much of the structure shown in the lower portion of the frame subsystem 300 in the embodiments illustrated.

FIG. 13 shows an alternate embodiment of the pedestal-style device in which a four-bar linkage straight-line approximation mechanism 246 forms the arm subsystem 312. This four-bar linkage also forms part of the vertical motion subsystem 308.

Additional elements of the vertical motion subsystem 308 are made up of a synchronizing (or equalizing) linkage 256 which couples to the radial links made up of the centering adjustment subsystems 310 coupled to the compliance subsystems 306 comprise the vertical motion subsystem 308. (As described earlier, these assemblies effectively make up a pair of radial links on either side of the user coupling the ball joints 210 to the sleeve bearings 224.) The synchronizing or equalizing mechanism 256 insures that as one of these radial link assemblies goes upwards the other one will move downwards.

Due to the synchronizing mechanism 256, the horizontal pivot bar 220 only needs to move up and down if the average height of the ball joints 210 changes. In other words, motions of the user's hips such as those that might occur in jogging in place or walking in place won't require much vertical motion of the pivot bar.

However, if the user moves from a standing to a kneeling position, for example, the average height of the two ball joints 210 will change and the synchronizing mechanism 258 causes the pivot bar 220 to move up and down along the substantially vertical straight-line coupler point path generated by the four-bar linkage 246.

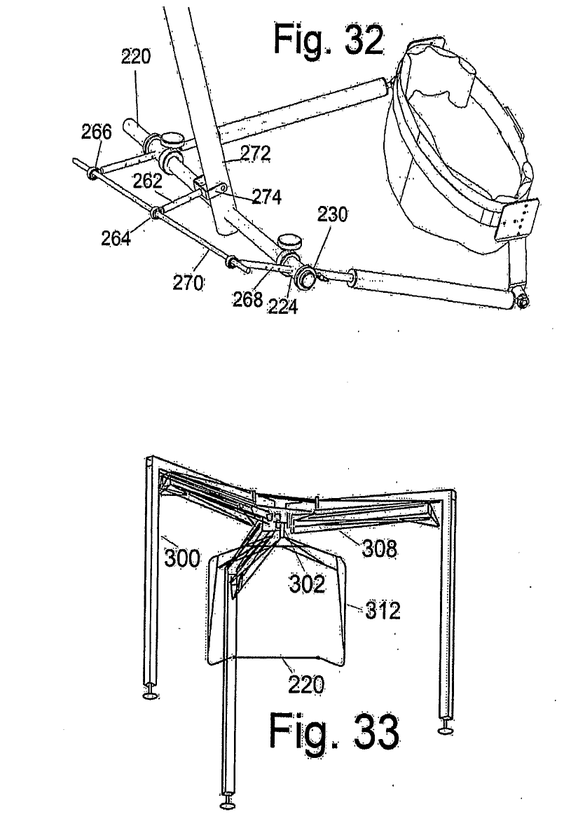

An alternate embodiment of the synchronizing mechanism 258 which might be employed is shown in FIG. 32.

Four-bar linkage 246 is made up of the four-bar's frame member 248, the pair of four-bar rocker members 250 and 252, and the four-bar coupler member 254 which is attached to the pivot bar 220. The rocker members 250 and 252 are pivotally connected to the frame member 248 and the coupler member 254 at the rotating joints 256.

The four-bar's frame is not fixed in space but is pivotally connected to the frame subsystem at 302. (It serves a similar function to that of the tubular member 216 of FIG. 8.)

The geometry of the four-bar mechanism has been synthesized to cause the bar 220 to move up and down in an approximately straight-line vertical motion.

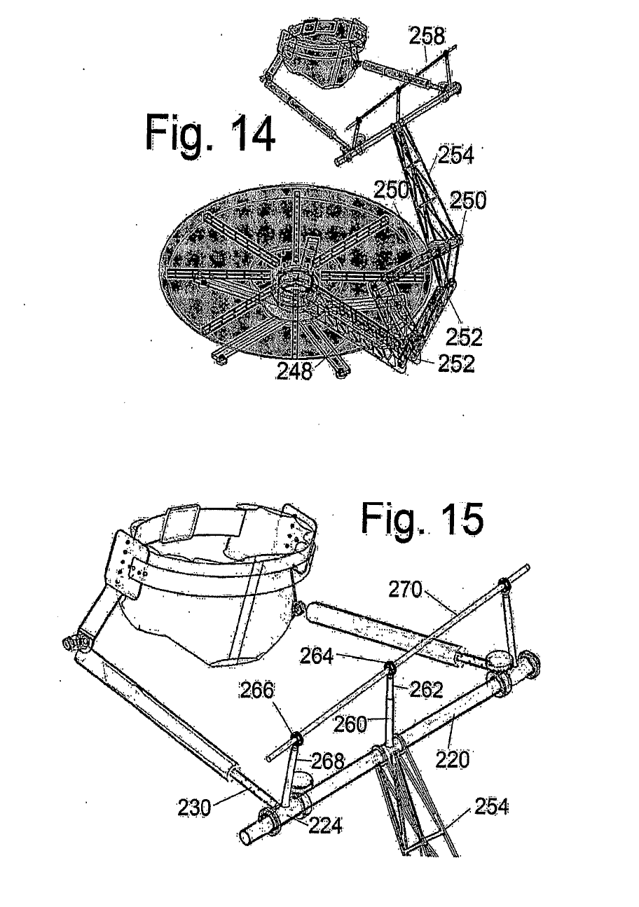

For strength, the four-bar links may be made up of pairs of members as is well known in the art of linkage design. This construction is shown in FIG. 14 where pairs of rocker links 250 straddle the four-bar's frame member 248 and the coupler member 254 as do pairs of rocker links 252.

Counterbalance mechanisms such as springs, bungee type cords, cable systems, or counterweights can be employed to balance some of the weight of the moving parts.

One possible embodiment of the equalizing mechanism 258 is shown in FIG. 15. Another is shown in FIG. 32.

Here, ball joint mounting tubes 268 are rigidly attached to the bearing shells 224 as are the telescoping tubes 230 from the centering adjustment mechanisms. Thus, when member 268 rotates about the pivot bar 220, member 230 (and the centering and compliance mechanism on that side of the user) will be forced to rotate by the same amount and vice versa.

A tubular member 260 is rigidly attached to the pivot bar 220 which is itself rigidly attached to the coupler link 254. Telescoping within that tube 260 is a mating member 262 that carries on it a ball joint 264. Member 262 is so disposed as to be able to plunge or slide in and out of member 260.

Synchronizing rod 270 is axially fixed with respect to the ball joint 264, say by means of snap rings on either side of the ball. In other words, it can freely rotate about the center of the ball joint 264 and the center of the rod can ride up and down when the member 262 plunges in and out of tubular member 260.

Ball joints 266 have cylindrical holes through their centers. Member 270 is so disposed as to pass through these cylindrical holes. These form sliding joints between the ball joints 266 and the rod 270. They allow member 270 to slide from side to side within the ball joints 266 if needed. Since they are ball joints, they also allow member 270 to vary its inclination with respect to the joints 266 as required.

Taken together, these elements force the two distal ball joints 266 to remain collinear with the central ball joint 264. If the joint 266 on one side of the user swings backward, say, then the other joint 266 will be forced to move forward. As these motions take place, the distance between the central ball joint 264 and the distal ball joints 266 will vary slightly. This slight variation in length is accommodated in the embodiment shown by the axial sliding of the rod 270 within the joints 266. It will be appreciated that other means could be employed to accommodate this change in length, such as by using flexural elements.

Similarly, as the two ball joints 266 swing about the pivot bar 220, the member 262 will be forced to vary its height, due to the difference between the length of the radius of the arc on which they are swinging and the height of the chord of that arc as seen from a projected view along the length of member 220. The sliding joint coupling members 262 and 260 enables that slight plunging motion to take place.

Other means could be employed to allow this slight change of length as well. For example, members 260 and 262 could be pivotally connected rather than via a sliding joint. Such a construction of an equalizing mechanism is shown in FIG. 32.

the purpose of the equalizing or synchronizing mechanism 258 just described is to insure that when the user makes gross up or down motions the four-bar linkage will move up or down to accommodate the change but that when the user makes minor motions of his or her hips the main linkage won't need to move. Thus the user feels very little reflected inertia from the heaviest parts of the vertical motion subsystem during many typical immersed virtual reality activities such as walking, turning, or jogging in place.

If there were no synchronizing linkage, the system would have one too many degrees-of-freedom. The four-bar linkage mechanism would simply drop to its lowest position (if there were no counterweight system) or rise or float depending on the strength of the counterbalance mechanism. It wouldn't be driven by the rotation about the pivot bar 220 except when the assembly was stretched out to its limit. The synchronizing mechanism 258 essentially creates just the correct freedom of motion by removing one degree-of-freedom from the combined system made up of the members pivoted about bar 220 together with the four-bar system, 246.

It will be appreciated that all of these “pedestal-style” embodiments have the virtue of providing a relatively clear field of view for the position-sensing virtual reality camera system or for other such sensors. They also provide clearance so that the user will have freedom to move the arms or legs or carried objects with minimal interference from colliding with the device.

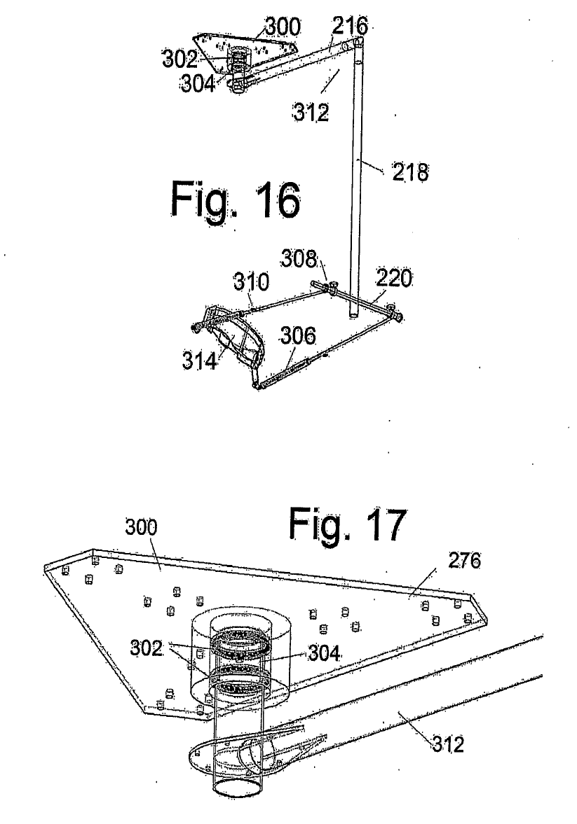

FIG. 16 shows an overhead embodiment of the present invention with the frame system 300 mounted to the ceiling. This is essentially an inverted version of the pedestal-style embodiment shown in FIG. 6. In this case, there is no need for a false floor 212, since the pivot system 302 is overhead allowing the user to walk on the real floor. Also, since the embodiment of the vertical motion subsystem 308 is of the type shown in FIGS. 6 through FIG. 12, there is no need for a synchronizing subsystem 258.

The embodiment in FIG. 16 has a frame subsystem 300 which can be mounted to the ceiling or other fixed overhead structures as shown in FIG. 17. For instance, FIG. 17 shows subsystem 300 mounted via a mounting plate 276 which could bolt to overhead supports.

Rotating bearings couple the frame subsystem 300 to the arm subsystem 312. This rotating bearing assembly comprises the pivot subsystem 302.

Collinear with the pivot assembly is a slip ring assembly 304 that comprises the main component of the cable management subsystem. If there is no need for continuous rotation, the slip rings can perhaps be omitted and the cable management could be implemented by other means. For instance, simply allowing extra cable length, perhaps in the form of a helical coiled cord, would allow some restricted rotation from side to side. It will be seen that the total number of turns clockwise or counterclockwise from the central “neutral” position would be limited in this case, due to the need to avoid breaking or tangling the cables.

It will be appreciated that other non-contacting methods of signal transmission, such as optical, RF, or magnetic couplings are feasible alternatives to the use of slip rings for signal transmission from the fixed to the movable portions of the system as components of the cable management subsystem.

The arm system 312 shown in FIG. 16 has horizontal members 216 and 220 and a vertical member 218. As in the embodiments shown in FIG. 8 and FIG. 12, one purpose of the vertical members 218 is to bring the pivot bar 220 to a convenient height relative to the floor on which the user rests so that the vertical motion subsystem 308 can provide the needed range of motion. For this reason, the vertical arm members will generally be longer in the overhead embodiments with fixed ceiling mounted pivots than was the case when the horizontal arm was below the false floor 212. It will be appreciated that the arm mechanism could be configured with single or multiple members 216 and 218 as was the case with the pedestal mechanisms such as FIG. 8 and FIG. 12.

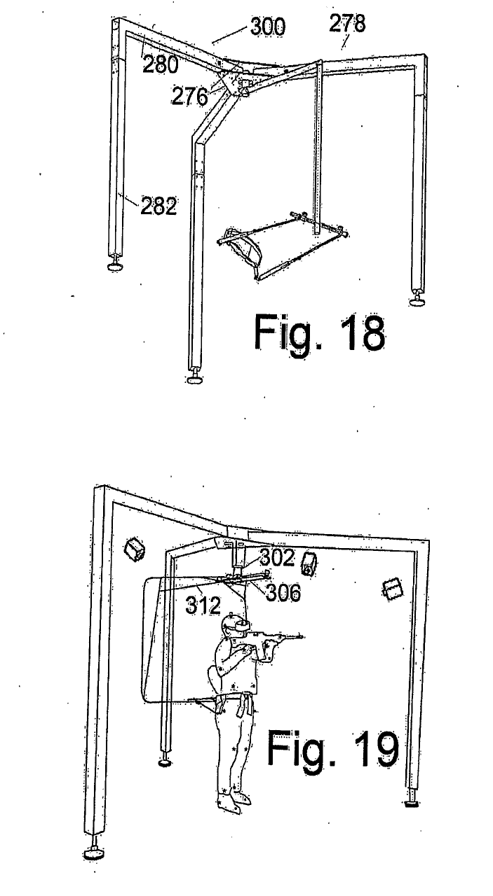

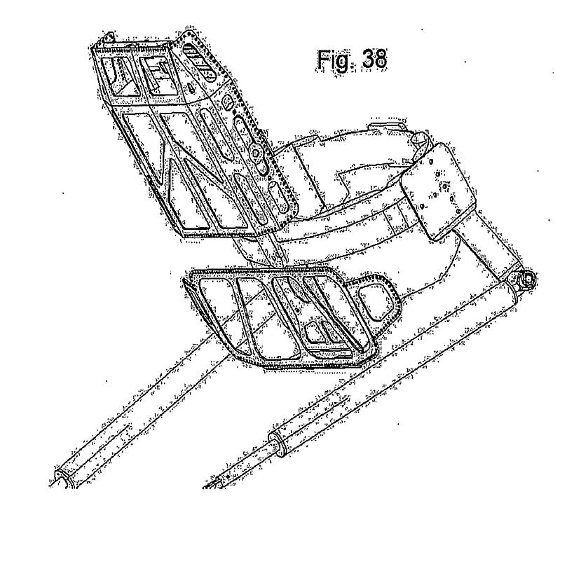

Other arm configurations could also be employed as desired for reasons such as strength, ease of fabrication, or minimizing rotational inertia. For example, FIG. 37 shows a preferred embodiment using diagonal arms 380 rather than vertical arms 218. This configuration provides additional strength and stiffness to the arms in the radial direction. It has the added desirable feature of providing lower rotational inertia than in the vertical arm configurations such as those shown in FIGS. 16 and 18.

As in the embodiments shown in FIGS. 6 through FIG. 12 described earlier, the overhead embodiments shown in FIG. 16, FIG. 17, FIG. 18, and FIG. 37 have a pivot bar 220 mounted on the arm subsystem. That pivot bar 220 carries the vertical motion subsystem 308, the centering subsystem 310, the compliance subsystem 306, and the human restraint harness subsystem 314. These subsystems work just as described earlier in the embodiment of FIG. 6.

An additional component of the compliance subsystem 306 is provided by the flexibility inherent in the arm subsystem. That flexibility can be enhanced if desired to play a greater role in the compliance subsystem 306, perhaps making some of the other components such as the springs 240 and 242 unnecessary.

FIG. 18 shows an overhead embodiment of the present invention with the frame system 300 defining an overhead support 278 and legs 282 for supporting the overhead support 278. In the embodiment illustrated, the overhead support is formed from three horizontal beams 280 together with a pair of central mounting plates 276. The horizontal beams 280 extend between the central mounting plates 276 and the ground engaging legs 282. Three ground engaging legs 282 are provided to support the assembly above the user during normal use.

It will be appreciated that many alternative construction arrangements could be employed for the frame subsystem. For example, a four-legged structure could be used.

As indicated before, the overhead support 278 can be attached directly to the ceiling or other support structure to eliminate the need for the legs 282.

Such an overhead support structure could be used with any of the overhead embodiments described. For example, the embodiment shown in FIG. 37 can either be attached to a frame structure such as that described previously and shown in FIG. 18 or it could be ceiling mounted with the stationary portion of pivot subsystem 302 attached to a frame subsystem 300 fixed to stationary overhead components in the room containing the virtual reality harness. Details of frame structure 300 are not shown in FIG. 37 since said structure can be implemented in these different ways as amply illustrated in the other figures.

It will be appreciated that the subsystems of this invention can be combined in different sequences to implement different embodiments as was shown in the illustrative schematics such as FIGS. 3 through FIG. 5. The embodiments shown in the attached Figures are therefore to be considered illustrative of some typical combinations of subsystems and not restrictive. For instance, an alternate implementation of the inverted embodiments shown in FIG. 16 and FIG. 18 could have the compliance subsystem 306 located between the pivot subsystem 302 and the arm subsystem 312 as shown in the embodiment of FIG. 19.

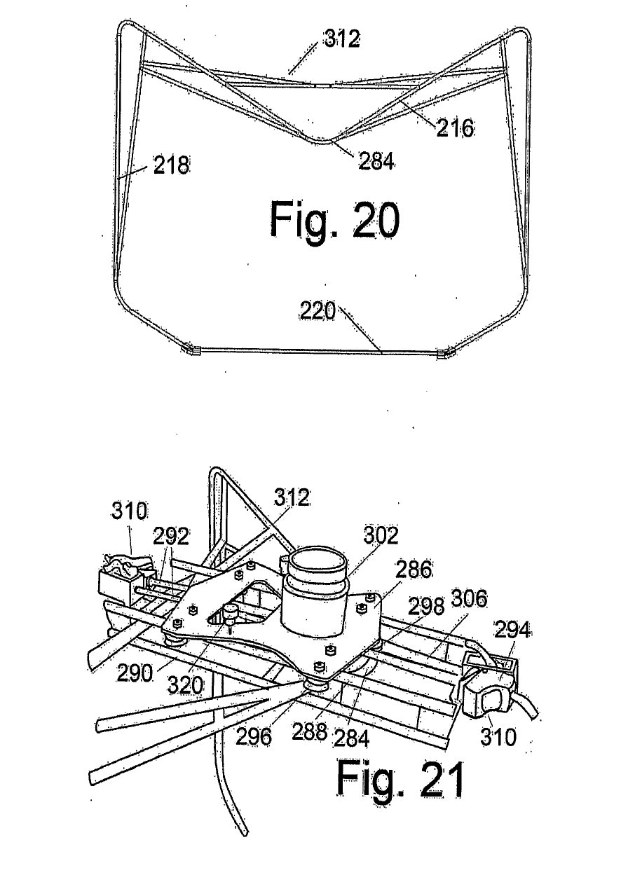

FIG. 20 shows the embodiment of the arm subsystem 312 shown in FIG. 19. The arm shown is made of bent tubular components to keep the weight to a minimum while retaining the necessary strength, but it has the essential elements shown in the other arm embodiments: essentially horizontal members 216, essentially vertical members 218, and a pivot bar 220. The arm attaches to its support in the vicinity of 284 at the top center of the arm.

FIG. 21 shows the embodiment of the mechanism 306 that couples the arm subsystem 312 of FIG. 19 to the pivot subsystem 302. This overhead mechanism embodiment combines the functions of the centering mechanism 310 and the compliance subsystem 306 into a single multifunction subsystem.

In this embodiment, the rotating portion of the pivot subsystem 302 mounts to a slide mechanism base 286 which can pivot about a vertical axis through 302 relative to the frame 300. Base 286 carries guide rollers 296 and pulley members 298.

A carriage assembly 290 is rigidly attached to the arm 312 and to guide rails 288. Guide rails 288 are constrained by the rollers 296 so as to limit the motion of the carriage assembly to a substantially radial horizontal motion through the center of the pivot assembly 302. The center 284 of the arm assembly 312 is rigidly attached to the carriage assembly 290 insuring that the carriage and arm will move radially in and out with respect to the pivot 302 as a single rigid assembly.

Elastic “bungee” style cords 292 are attached to the carriage assembly in the vicinity of quick release cord locks 294. These elastic cords loop around pulleys 298 mounted on the slide mechanism base 286 and then return to the cord locks 294 where they are captured by the locks. By differentially tensioning the cords 292 in the locks 294, the carriage assembly with the arm 312 can be radially adjusted thereby implementing the function of the centering adjustment subsystem 310. Further, by varying the tension in the elastic cords 292 by stretching them to a greater or lesser degree prior to closing the quick release cord locks 294, the amount of compliant centering force applied to the arm 312 can be adjusted. This allows the centering force to be readily “tuned” to the needs of the application and the particular user. Thus, in this embodiment, these elastic elements 292 also implement the function of the compliant centering subsystem 306.

As indicated by the schematics of FIGS. 3, 4 and 5, the location of the vertical motion subsystem 308 could be moved above the pivot subsystem 302 and below the frame subsystem 300 to obtain still more embodiments of the present inventions.

Such embodiments with the vertical motion subsystem 308 above the pivot subsystem 302 possess the unique advantage of orthogonalizing the vertical translational inertias and the angular rotational inertias. Uncoupling the vertical translational inertia component from the rotational inertia component has the advantage of allowing the rotational inertias to be minimized, making the present inventions feel more natural to the user.

With these embodiment configurations, the weight of the vertically moving system components (which make up most of subsystem 308) can be readily counterbalanced by any of several well-known techniques. For instance, constant force springs or cable counterweight systems could be used for this purpose.

The users of the present inventions are relatively insensitive to vertical loads and vertical linear inertias caused by the weight of the moving apparatus because these vertical load components are transmitted by the human restraint harness subsystem 314 directly to the user's waist, hips and legs.

On the other hand, users are very sensitive to excessive rotational inertias. Such inertias would make the system feel very unnatural during rapid turning and stopping maneuvers. If the swinging arm subsystem 312 also needed to carry the mass of a heavy vertical motion subsystem the users would have difficulty performing such rapid maneuvers.

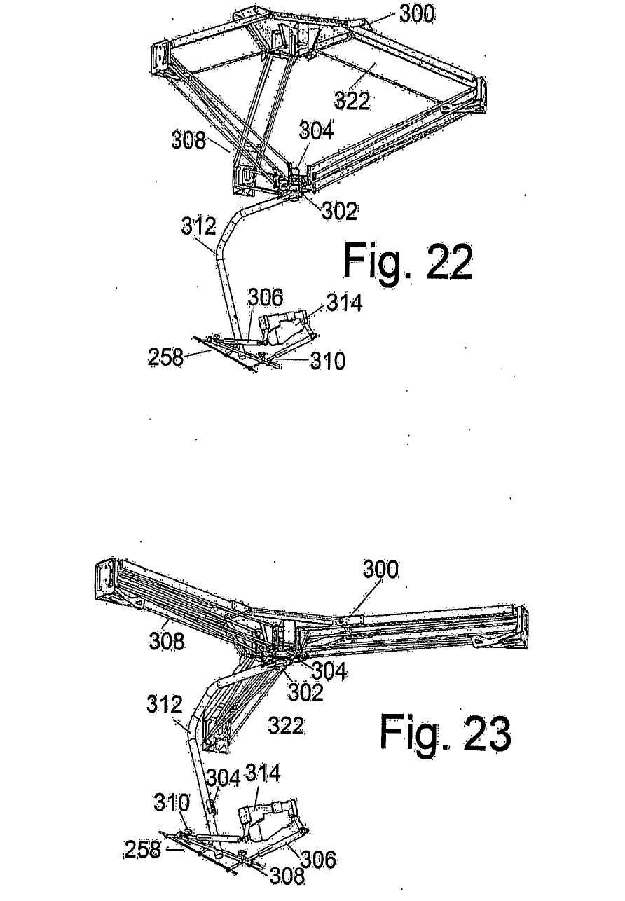

With the configurations presently under discussion, the mass of these rotating components is kept to a minimum since the vertical motion mechanism 308 is separate and is not required to turn. Several variants of such embodiments are shown in FIGS. 22 through FIG. 34. These embodiments orthogonalize the vertical and translational inertias so the user can turn freely with minimal rotational resistance.

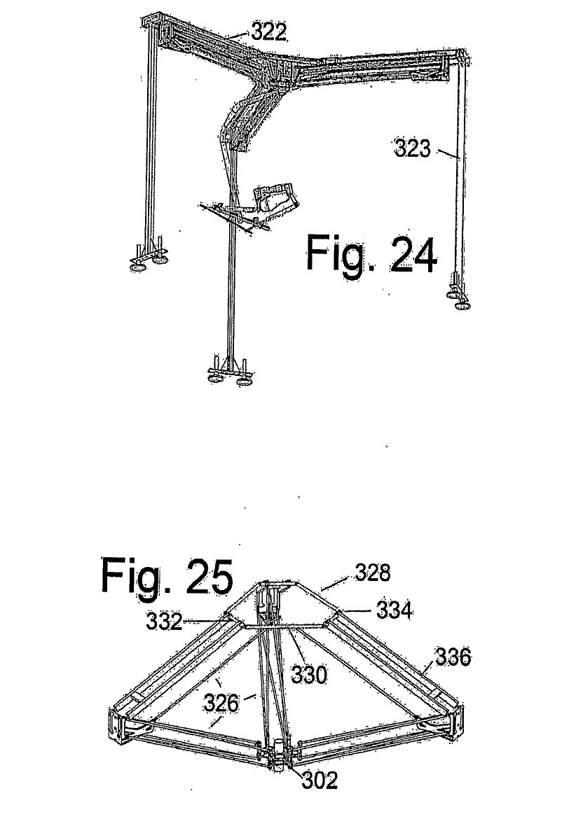

FIG. 22 shows a ceiling mounted embodiment of a single arm version of the present invention that uses a unique straight-line mechanism 322 as the primary component of the vertical motion subsystem 308. This embodiment is shown with the vertical motion subsystem 308 in a lowered position in FIG. 22 and with it in a raised position in FIG. 23.

FIG. 24 shows a floor-mounted version of this same system in an embodiment with a support frame 322 with three ground engaging legs 282. To minimize the overall height required by the system, the frame structure has been designed with horizontal outside members 324 which straddle the vertical motion linkage and allow it to tuck up inside the frame in the raised configuration.

FIG. 25 shows an oblique view of the primary components of the vertical motion and pivot subsystems when the mechanism is in a lowered position. For clarity, the frame subsystem 300 has been omitted. It can be seen that in the preferred embodiment of this system, the vertical motion subsystem comprises three identically configured sets of articulated arms 326 that move in a scissors-like fashion in an up and down direction. These arms are disposed at 120 degrees to one another as seen from above and serve to guide the pivot subassembly 302 in a substantially straight-line vertical path. It would be possible to implement this invention with a different number of arms, say four, but three is a preferred number for most applications.

As seen in FIG. 25, there is a six-sided closed-loop of universal joints 328 at the top of these articulated arms 326. This set of universal joints consists of longer universal joint members 330 interconnected by Hooke couplings 334 with shorter universal joint members 332 in an alternating long short arrangement.

These universal joints are pivotally mounted to the frame 300 and rotate in unison within bearings 342 so that if one is forced to turn by some externally applied torque they will insure the same rotation of the others. Since they form a closed loop, they will serve as an equalizing system sending this restoring torque both ways around the loop from the member that is being loaded to the other members. This minimizes the tendency of the members to twist or “wrap up” as the torque moves from member to member as might be the case with an open chain of joints. Thus, even though the closed chain is theoretically over constrained, it offers superior performance as an equalizing or synchronizing device for the purpose of the present inventions.

FIG. 25 also shows that there is an upper set of three linkage members 336 each of which is rigidly coupled to the shorter members 332 of the closed chain 328 of universal joints. Thus, each of these arm members 336 pivotally rotates about a fixed axis on the frame at its upper (most central) end. Seen from above, these arms are at 120 degrees to one another.

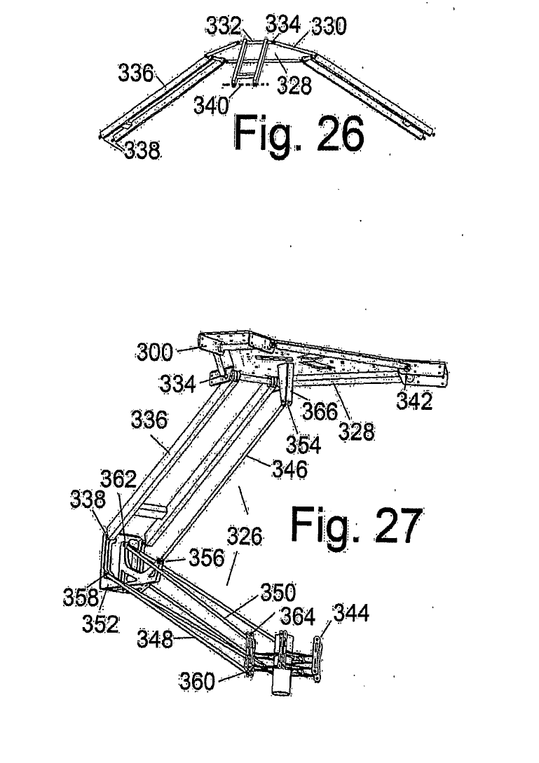

FIG. 26 is an oblique view showing how the six-sided universal joint loop 328 synchronizes the motion of the three sets of upper arm members 336. The other parts have been omitted for clarity. These three sets of arms 336 are forced by the universal joint chain 328 to move in unison against any outside forces. Conversely, the fact that these components 336 are constrained to move in unison helps force the members which are attached to their lower ends via the pivoting joints 338 to move symmetrically and in unison. (These pivoting joints 338 could either be ball joints or hinge joints whose axes on each member 336 are collinear.)

As will be seen later, there are other structurally redundant mechanisms that also force these elements to move in unison. The net effect of all these redundant systems is to enhance the stiffness of the overall invention and allow a fairly light construction to withstand significant forces from the user while still maintaining the pivot subassembly 302 in a substantially centered and upright orientation.

Further, due to the torsional rigidity of upper arm members 336, the pair of pivot joints 338 on each member 336 will define a horizontal line 340 at the lower distal end of each member 336. Due to the net effect of the elements shown in FIG. 26, all six joints 338 are constrained by multiple effects to lie in a single horizontal plane and the three 120 degree apart lines 340 defined by the six sets of joints 338 will all be coplanar as well. Disturbing forces resulting from the loads imposed by the user of the harness will attempt to distort this configuration but the multiple recirculating force paths will tend to maintain the desired symmetry.

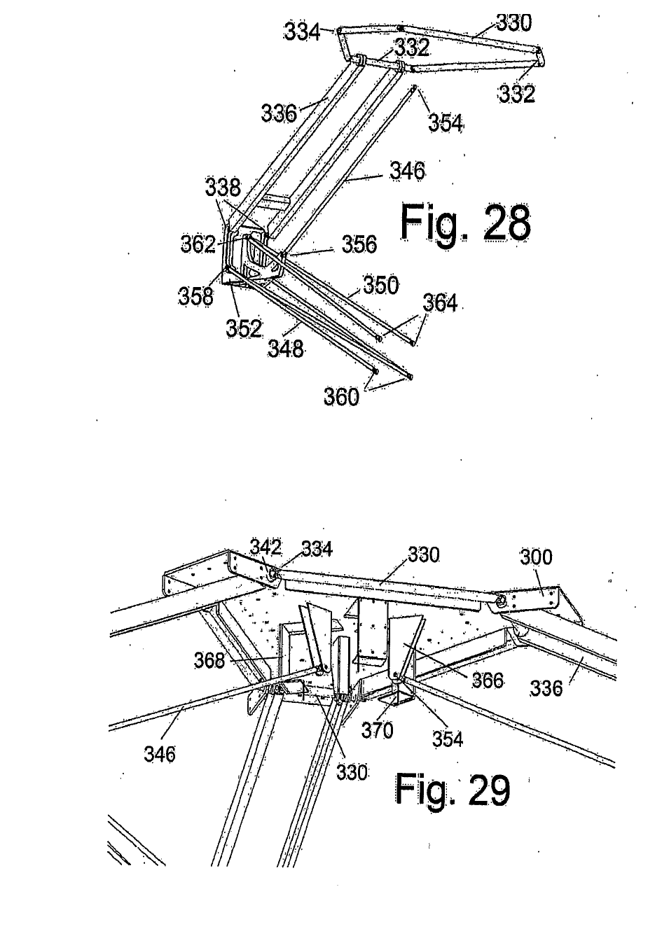

FIG. 27 shows one of the three sets of articulated arms 326 of the vertical motion mechanism 308 when the mechanism is in the lowered position along with the center mounting portion of the frame 300, the universal joint chain 328 in its bearings 342, and the pivot support hub platform assembly 344. FIG. 28 shows the same oblique view but with the frame and the pivot mount omitted for clarity.

As seen in FIG. 27, there is a bracket 366 rigidly attached to the frame 300. This bracket 366 is pivotally connected to an upper connecting link 346 by means of rotating joint 354. (Many of the joints in the present invention could be either ball joints or hinge joints depending on the embodiment. Hinge joints add somewhat to the structural stiffness by adding redundant constraints but at the expense of creating internal stresses if the parts aren't accurately sized and aligned. When either will suffice for the purpose of this invention, they will simply be referred to hereafter as pivotal or rotating connections.)

The lower end of connecting link 346 is pivotally connected to an intermediate translating link 352 at point 356. This intermediate translating link 352 is also rotatably coupled to the upper arm members 336 by the joints 338.

The perpendicular distance between pivot 354 and the upper hinge axis for link 336 (the universal joint axis) is chosen to be equal to the perpendicular distance between the pivot 356 and the axis line 340 defined by the lower joints 338 attached to links 336. Similarly, the length from the pivot axis on the universal joint member 332 to the line 340 defined by the lower end pivots 338 on the links 336 is chosen to be the same as that of the members 346 measured from the center of pivots 354 to the center of pivots 356. In this way it can be seen from FIG. 27 that a parallelogram mechanism is formed with links 336 always constrained to be parallel to the corresponding links 346 and the translating links 352 always constrained to be parallel to the corresponding portions of the frame 300. Thus, the three links 352 will always move in synchronism and with pure curvilinear translation as they swing on vertical arcs about the frame 300.

FIG. 27 also shows that there is a lower parallelogram mechanism coupling the intermediate translating link 352 to the pivot support hub platform assembly 344. This parallelogram mechanism is made up of the lower arm member links 348 which are disposed parallel to the lower connecting links 350 and the intermediate translating links 352 which are arranged opposite to portions of the support hub platform assembly 344. This configuration can perhaps be visualized more clearly by referring to FIG. 28 where the support hub platform assembly 344 has been omitted.

The lower arm member links 348 have a pair of pivots 358 at their juncture with the intermediate translating links 352 and another pair of pivots 360 at their lower (most central) ends where they couple to the support hub platform assembly 344. The two pivots at 358 define a substantially horizontal hinge axis as do the two pivots 360. These two hinge axes are constrained to always be substantially parallel to one another and at a substantially constant length from one another. The V shaped lower connecting link 350 has a central pivot or ball joint 362 which is always the same distance from the hinge axis line formed by the line between the pair of pivots 364 on the link 350. Similarly, the two pivots 358 on the intermediate translating links 352 define a hinge axis that is the same perpendicular distance from pivot 362 as is the distance between the hinge axis line defined by joints 364 and that defined by joints 360. Thus the V shaped lower connecting members 350 and the lower arm member links 348 form opposite sides of a parallelogram linkage as do the intermediate translating links 352 and the support hub platform assembly 344. The V shaped lower connecting members 350 are configured that way so as to clear the member 346 and the pivot 356, though there are many other possible ways that that could be accomplished within the spirit of this invention.

Thus, it will be observed that one set of articulated arms 326 is theoretically sufficient to constrain the support hub platform assembly 344 to remain in a horizontal orientation and to move with a planar motion. The vertical pivot axis can be considered to lie within the reference plane for that planar motion.

Having two such sets of arms whose reference planes form a dihedral angle and are not coplanar is, in theory, sufficient to insure that the support hub platform assembly 344 will only be capable of straight-line vertical translation. In fact, this would be true even if the universal joint system 328 were omitted. Theoretically, from a kinematic structure point of view, it is somewhat over constrained but this isn't a practical problem since the critical pivot axes all intersect at infinity.

However, that theory is based purely on geometric considerations. Under load from a user, the components will distort. The fact that the mechanism as described is somewhat over constrained is beneficial in that it minimizes this distortion under applied loads. Utilizing three sets of arms makes it even more over constrained and provides even more redundant paths through which the forces can travel minimizing the distortions still further.

Finally, having the universal joint chain 328 makes the device still further over constrained and helps additionally to minimize the deflections in the parts and to keep the central pivot mount 344 substantially centered and with the pivot substantially vertical. The universal joint chain provides additional routes through which forces and torques can flow to provide restoring forces to the structure.

To aid in visualizing how this works, consider what would happen if loads from the user were to force the central pivot platform 344 off center causing one of the links 336 to swing up and outwards. If there were no universal joint chain 328, the other links 336 would be tugged downwards by this motion of the central pivot platform. However, due to the coupling through the universal joint chain 328, the other links 336 are compelled to rise up and outwards by the same amount as the first link thereby urging the pivot subsystem 302 to remain centered and vertical despite flexing and distorting loads imposed by the user.

FIG. 29 shows a detailed view of the upper center portions of the embodiment of FIG. 22. This shows the area near where they mount to the frame with the mechanism in the down position.

FIG. 29 also shows three brackets 368 attached to the frame on which constant force spring motors can be mounted to pull cables 370 attached to the central pivot hub platform assembly. In this way, the vertical static loads of the harness system can be completely balanced so that the user doesn't feel any static vertical load.

In fact, for safety, the counterbalance system can be given a slight amount of lift so that if the user takes off the human restraint harness mechanism 314, the mechanism will drift upwards and not fall towards the user.

One skilled in the art could select any of a number of other well-known counterbalance devices to use in place of the constant force spring motor assemblies used in the present embodiment.

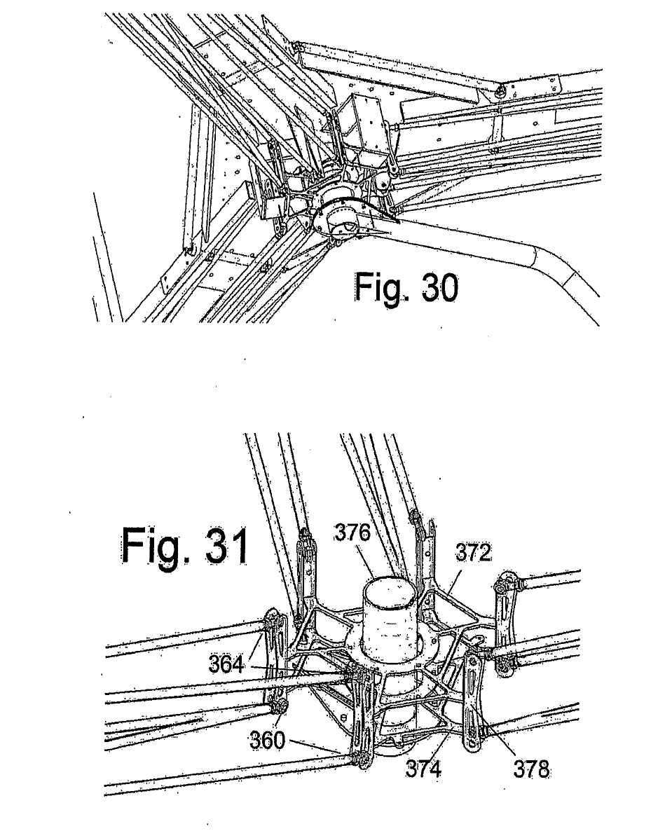

FIG. 30 shows an oblique view looking up at the center of the complete FIG. 24 embodiment with the mechanism in the raised position.

FIG. 31 shows an oblique view looking down at the center of the pivot hub assembly 344 of the FIG. 24 embodiment with the mechanism in the lowered position. This shows one preferred embodiment in which the six mounting brackets 378 for the pivotal connections 364 and 360 are welded to upper bearing mounting plates 372 and lower bearing mounting plates 374 to form a single rigid assembly. Tubular member 376 is constrained to pivotally rotate on that assembly by means of bearings (not shown) whose outer races engage the holes in the upper and lower mounting plates and whose inner races engage the tubular member 376. Said member 376 is prevented from slipping axially within the bearings by shoulders and bearing surfaces not shown but well known in the art.

Inside tubular member 376 and also not shown is a collinear set of slip rings 304 which manage the transition of the necessary video and audio cables for the virtual reality system from the rotating members that turn with the arm to the portions that simply need to flex slightly as the mechanism moves up and down. These slip rings 304 comprise a major component of the cable management subsystem. It will be appreciated that other non-contacting methods of signal transmission, such as optical, RF, or magnetic couplings are feasible alternatives to the use of slip rings for signal transmission from the fixed to the movable portions of the system as components of the cable management subsystem. If there is no need for continuous rotation, said slip rings 304 can perhaps be omitted and cable management could be implemented by other means. For instance, simply allowing extra cable length, perhaps in the form of a coiled cord, would allow oscillating rotation from side to side. It will be seen that the total number of turns clockwise or counterclockwise from the starting position would be limited in this case, due to the need to avoid tangling the cables.

The arm system in this embodiment functions much like that shown in the embodiments described earlier, say that of FIG. 18 with the exception of the fact that it moves up and down as well as rotating. As in the case of the embodiment of FIGS. 13 and 14 which also had a vertical motion linkage, a synchronizing mechanism is necessary to isolate minor hip motions from the main vertical motion linkage and to drive the vertical motion subsystem 308 when the average height of the user's hips moves up or down.

FIG. 32 shows one embodiment of a synchronizer linkage similar to that shown in FIG. 15 as it might be employed in the overhead linkage embodiments. The embodiment of FIG. 15 could also be adapted to serve for this purpose. Either form of the synchronizer invention (that of FIG. 32 or that of FIG. 15) could be employed in either the pedestal linkage system of FIG. 14 or in the overhead embodiments such as that illustrated in FIG. 22. The only difference between the two synchronizer devices is that one employs a sliding coupling between members 260 and 262 with member 260 rigidly attached to bar 220 which is rigidly attached as part of the arm member and the other employs a swinging motion of part 262 via a yoke 274 pivotally coupled to the arm 272 to accomplish the same purpose.

Since the vertical inertial loads are taken by the human restraint harness mechanism and transmitted to the user's hips and legs, they are almost unnoticed by the user during normal immersed activity. Further, due to the synchronizer linkage shown in FIG. 32 which functions much as was described in the discussion of the embodiment of FIG. 14, the vertical motion linkage doesn't need to move much during normal small hip motions of the user such as in walking or jogging in place.

In both the overhead straight-line vertical linkage embodiments currently being discussed and the pedestal vertical linkage embodiments such as was shown in FIG. 14, the purpose of the straight-line linkage subsystem was to move a pivot bar 220 up and down as needed to accommodate vertical motions of the user. The way in which the human restraint subsystem 314 functions is the same in both embodiments and its description will not be repeated here.

One point to note is that in either of the embodiments using a straight-line linkage mechanism, the members pivoting on the bar 220 and coupling the user to the bar (perhaps via the centering adjustment mechanism and/or the compliance system) don't need to be as long as those in the case of the embodiments in which the pivot bar 220 remains at a constant height above the floor. This is because the latter devices depend on the long length to produce an arc motion of the user's hips that is a close approximation to a vertical straight line.

Thus, the various embodiments of these inventions present various design trade-off possibilities. Different configurations present different possibilities for packaging (space considerations), robustness, rotational and translational inertias reflected to the user, and so forth.

FIG. 33 shows an embodiment with an overhead straight-line vertical motion linkage subsystem 308 of the type shown in FIGS. 22 through FIG. 31 and described earlier. It uses a tubular dual leg arm subsystem 312 of the type shown in FIG. 20. The centering 310 and compliance 306 subsystems used in this embodiment could be overhead but beneath the pivot subsystem 302 using a system such as the invention shown in FIG. 21 or they could be of the forms shown in FIGS. 10 and 11. The cable management subsystem is of the type shown in FIG. 31 and in a preferred embodiment is located on or within the vertically translating pivot 302. Also, either of the synchronizing system inventions described earlier (that of FIG. 32 or that of FIG. 15) could be used. For these reasons, FIG. 33 does not show the specific components attached to the horizontal pivot bar member 220.

FIG. 34 shows part of a similar embodiment but with a composite structure forming dual leg arm subsystem 312.

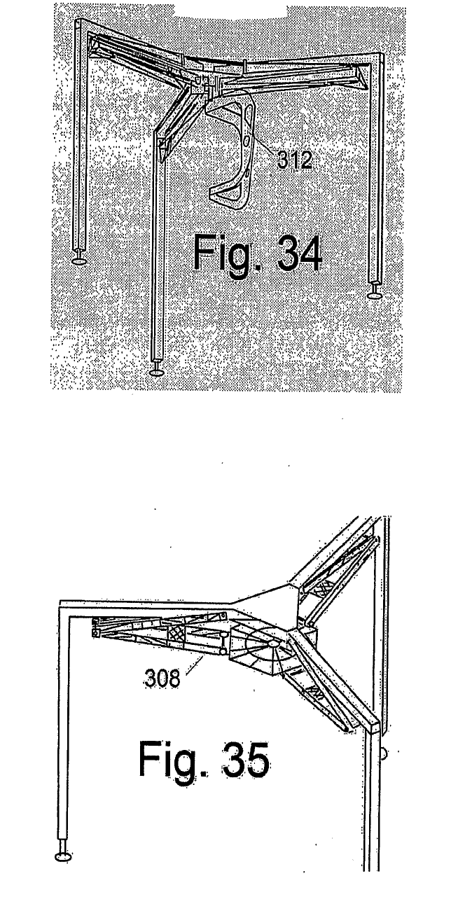

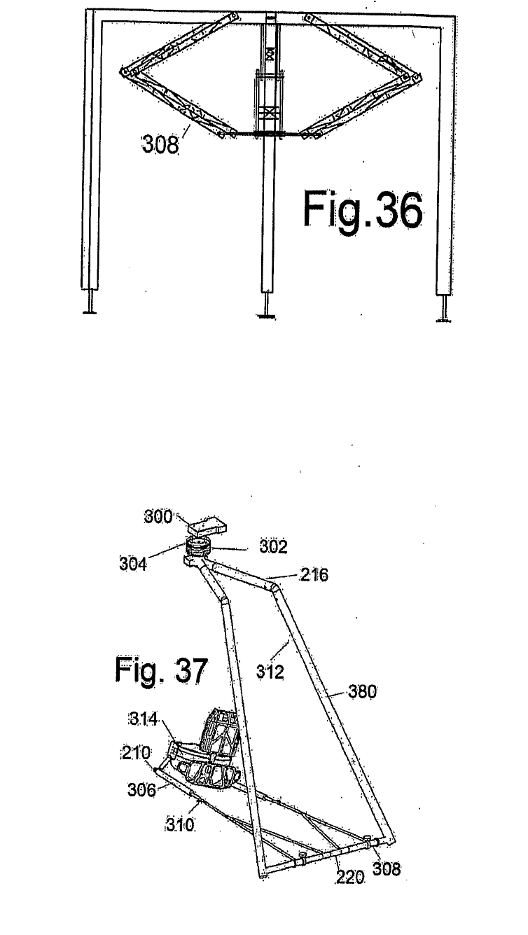

FIGS. 35 and 36 show a modified embodiment of the present invention that employs a spatial straight-line linkage to provide the vertical motion subsystem 308. This spatial linkage is based on a modification and extension of the well-known “Sarrus” principle for providing pure translation of a plane surface in space where the translation is perpendicular to the plane surface. Each of the three sets of articulated arms employs a single pair of linkages rather than the vertically doubled up pairs of parallel linkages shown in the earlier devices. This embodiment lacks the “double deck” parallelogram structures of the previously described straight-line mechanisms so it is less stiff and robust than the highly over constrained versions shown in the preferred embodiments. This embodiment could also be implemented with the closed-loop universal joint chain 328 shown earlier in FIG. 28. Doing so would make it over constrained. As descried earlier, it would provide multiple paths for restoring forces and torques and would be more stiff and robust while gaining little additional inertia.

One unique aspect of the overhead straight-line linkage embodiments described herein is the fact that they deliberately violate many traditional engineering rules for kinematic design in order to maximize the strength of the overall system while minimizing the rotating mass. To achieve this goal, the vertical motion subsystem 308 straight-line linkages utilize a highly over constrained mechanism structure. This creates multiple redundant paths for the forces and torques applied by the user to flow through the structure and create restoring or equalizing forces that keep the pivot subsystem 302 centered and vertical despite these disturbing forces.

Creating these multiple flow paths for the restoring forces is accomplished by combining multiple well-known elementary mechanisms in an innovative fashion not previously disclosed. Multiple mechanisms work in parallel to try to keep the center pivot vertical and centered. When one mechanism deflects or is overloaded by disturbing forces from the user, it provides feedback through the system to the other redundant mechanisms driving them to help correct the misalignment. In this way, recirculating flows of forces and torques in the device allow the individual elements of the system to be made lightweight and yet allow the system to withstand heavy horizontal loads from the user that would otherwise cock the pivot from vertical and push it off center.

While various embodiments have been shown to illustrate the invention, it will be understood that various changes and modifications can be made to the invention. In each of the embodiments described herein, the harness assembly is adapted for use with appropriate sensors, cameras and imaging devices for use with virtual reality software programs. The harness assembly includes appropriate wire and cable connections that are connected to the sensors and headset worn by the user and in turn connected to the appropriate computer system.

One such modification to the embodiments shown herein would be the addition of actively driven servoactuators to one or more of the joints of the harness, say the central pivot for example. These servoactuators could be driven to either reduce the inertial effects felt by the user or to provide haptic cues to enhance the immersed virtual reality experience. Sensors such as shaft position encoders or strain gages could be added to joints or members of the harness to provide input signals and feedback regarding loads applied to the harness. These signals could be processed locally and fed to said servoactuators or servomotors or they could be processed by a remote computer via the cable management system. Similarly, power for the servoactuators could be transmitted via the cable management system.

The harness assembly allows the user to walk, jog or, in some embodiments, crawl in place without undue restriction and while restraining the user within the specified area defined by the field of view of the virtual reality system. In each of the embodiments, the mechanical components of the harness are preferably spaced from the body of the user so as to allow the user to move his or her body without interference from the support arms or other structure. For example, the user can lean backwards and twist from side to side without their arms, head or upper body contacting the support arms of the assembly and when the user is prone the system will not interfere with motion of the arms or legs.

The virtual reality harness inventions may be embodied in other specific forms without departing from the spirit or essential characteristics thereof. The present embodiments are therefore to be considered illustrative and not restrictive. The scope of the inventions is to be indicated by the appended claims rather than by the foregoing description and all changes which come within the meaning and range of equivalency of the claims are therefore intended to be embraced herein.

1. A harness system for a virtual reality system, comprising: a. a frame subsystem with floor or ceiling engaging components b. a pivot subsystem with a substantially vertical pivot axis c. a cable management subsystem with components that prevent electrical cables from twisting or tangling as said harness moves d. a compliance subsystem which provides a centering force to the user e. a vertical motion subsystem which allows the user to move in a substantially up and down direction while substantially constraining horizontal motions. f. a centering adjustment subsystem which establishes the nominal position of the user in relation to said substantially vertical pivot axis g. a support arm subsystem which rotates around said substantially vertical pivot axis h. a human restraint subsystem which couples the user to said harness system and compels said support arm subsystem to rotate around said substantially vertical pivot axis.

2. A harness system for a virtual reality system, as set forth in claim 1 , wherein said frame subsystem comprises: a. a false floor rigidly attached to a central column b. a bottom portion of said central column rigidly attached to a member with ground engaging surfaces or feet.

3. A harness system for a virtual reality system, as set forth in claim 2, wherein said pivot subsystem comprises; a. one or more bearings beneath the false floor b. said bearings surround said central column.

4. A harness system for a virtual reality system, as set forth in claim 3, wherein said support arm subsystem comprises:
a. one or more substantially horizontal members that rotate on said bearings beneath the false floor b. a horizontal pivot bar member rigidly coupled to said substantially horizontal members by means of intermediate spacing members attached near the distal end of said horizontal members c. said horizontal pivot bar member so disposed as to remain at a substantially constant height above the false floor.

5. A harness system for a virtual reality system, as set forth in claim 4, wherein said vertical motion subsystem comprises: a. a pair of arm members pivotally coupled at their outer ends to said horizontal pivot bar member and so disposed as to swing in a substantially vertical plane relative to said horizontal pivot bar. b. said arm members coupled at their inner ends to said human restraint subsystem.

6. A harness system for a virtual reality system, as set forth in claim 1 , wherein said human restraint subsystem comprises: a. a wearable component adapted to be attached around the waist or torso of a user. b. a coupling means connecting each lateral side of said wearable component to one of said arm members c. said coupling means allowing limited relative motion between said wearable component and said arm members.

7. A harness system for a virtual reality system, as set forth in claim 2, wherein said cable management subsystem comprises a slip ring system beneath said false floor and surrounding said central column.

8. A harness system for a virtual reality system, as set forth in claim 2, wherein said cable management subsystem comprises a helical coil of cable beneath said false floor and surrounding said central column.

9. A harness system for a virtual reality system, as set forth in claim 1, wherein said centering adjustment subsystem comprises:
permitting the nominal unloaded or unstressed radial dimension of said arm members to be varied such as by telescopically or slideably coupled members within said arm members b. locking means to hold the nominal unloaded or unstressed radial dimension of said arm members constant, say by a quick release pin mechanism.

10. A harness system for a virtual reality system, as set forth in claim 1, wherein said compliance subsystem comprises: a. spring means permitting the radial dimension of said arm members to vary from their nominal unloaded or unstressed dimension setting in response to external forces applied to the harness system b. said spring means incorporate suitable resistive elements such as coil springs, leaf springs, elastomeric bands, or air springs acting against components such as telescopically or slideably coupled members within or carrying portions of said arm members.

11-68. (canceled)
